(19) United States
(12) Patent Application Publication
(10) Pub. No.: US 2012/0245936 A1
(43) Pub. Date: Sep. 27, 2012

(54) Device to Capture and Temporally Synchronize Aspects of a Conversation and Method and System Thereof

(76) Inventor: Bryan Treglia, Chandler, AZ (US)

(21) Appl. No.: 13/429,461

(22) Filed: Mar. 26, 2012

Related U.S. Application Data
(60) Provisional application No. 61/467,389, filed on Mar. 25, 2011.

(51) Int. Cl. G10L 15/26

(52) U.S. Cl. 704/235; 704/E15.043

(57) ABSTRACT

A system, device, and method for capturing and temporally synchronizing different aspect of a conversation is presented. The method includes receiving an audible statement, receiving a note temporally corresponding to an utterance in the audible statement, creating a first temporal marker comprising temporal information related to the note, transcribing the utterance into a transcribed text, creating a second temporal marker comprising temporal information related to the transcribed text, temporally synchronizing the audible statement, the note, and the transcribed text. Temporally synchronizing comprises associating a time point in the audible statement with the note using the first temporal marker, associating the time point in the audible statement with the transcribed text using the second temporal marker, and associating the note with the transcribed text using the first temporal marker and second temporal marker.

### CROSS REFERENCE TO RELATED APPLICATIONS

This application claims the benefit of U.S. Provisional Patent Application No. 61/467,389, filed Mar. 25, 2011, titled “Device to Capture Temporally Synchronized Aspects of a Conversation and Method and System Thereof,” the entire contents of which are hereby incorporated by reference herein, for all purposes.

### FIELD OF THE INVENTION

The disclosure relates in general to a method, device and system for capturing and synchronizing various aspects of a spoken event. In certain embodiments, the disclosure relates to capturing audio of a spoken event and user notes relating to the spoken event, generating a transcription of the spoken event and temporally synchronizing the audio, the user notes, and the transcription. In other embodiments, the disclosure relates to capturing audio of a spoken event and user notes relating to the spoken event, generating a transcription of the spoken event, generating a translation of the spoken event, and temporally synchronizing the audio, the user notes, the transcription, and the translation.

### BACKGROUND OF THE INVENTION

Techniques for recording the spoken word and converting such recording into text have long existed. For example, stenographers record the spoken word as it is being uttered in a shorthand format, which consists of a number of symbols. The shorthand notation is later transformed into normal text to create a transcript of the words spoken. This process is labor intensive as it requires a person to execute both conversions, first the conversion of spoken word to shorthand and second the conversion of shorthand to readable text. Stenographers are still widely used in courts of law.

Advances in microelectronics have led to the development of recording devices that allow the spoken word to be instantly captured in a digital format. These recording devices, combined with a playback device that allows the recording to be rewound and played back at variable speeds, allows an individual to convert the recording to text at a later time.

Advances in computer technology and audio processing have led to “speech to text” (“STT”) software, which can process the analog or digital recordings of the spoken word and convert the recordings to text. This removed the individual from both the recording function and the transcription function.

The accuracy of STT software to convert speech to text is limited by a number of factors, including microphone quality, processing power, processing algorithms, room acoustics, background noise, simultaneous speakers, and speaker annunciation. Current STT technology requires a relatively high quality recording to achieve a usable accuracy. The most accurate STT technology is able to achieve accuracy above 90% by requiring a high quality headset-type microphone and by “training” the algorithm to a specific speaker. While these highly accurate STT systems are ideal for dictation and hands-free computer operation, they are not appropriate for situations involving multiple speakers, such as meetings, interviews, depositions, conference calls, and phone calls. In addition, obtaining a high quality recording is relatively difficult in a multi-speaker environment. Short of equipping each speaker with a microphone, which would be anywhere from cumbersome to impossible, a recording of a multi-speaker conversation must necessarily include background noise, be limited by the acoustics of the venue, and include instances of simultaneous speakers. These factors result in lower transcription quality, which reduces the usefulness of such a transcription. Also, while a human-performed transcription achieves the highest accuracy with multi-speaker audio, it is prohibitively expensive in many applications. Accordingly, it would be an advance in the state of the art to provide a device, system, and method to improve the usefulness of a relatively low quality STT transcription so it is nearly as useful as a high quality human-performed transcription by leveraging the corresponding audio.

An individual participating in a multi-speaker conversation often takes notes of the conversation. These notes serve to capture highlights of the conversation, but can also include information that is relevant to the conversation, but which is not included in the audio record, such as the individual's thoughts, ideas, observations, or follow-up points. This extra information is often very valuable after the conversation.

Conversations, therefore, generally contain at least two types of information and, in some cases, at least four types. The first and second types are the audio of the conversation and the notes taken by an individual, respectively. The third is the transcribed text. And, the forth is video taken during the conversation, which may be of, for example, the conversation participants or a computer display shown during the conversation. While these types all relate to the conversation, they contain different information, with different aspects, and in different forms. When referring back to the conversation at a later time, it is somewhat difficult, tedious, or impossible to recreate the full picture of the conversation by determining, for a given time, the specific information from the different types of information. Accordingly, it would be an advance in the state of the art to provide a device, system, and method to capture multiple aspects of spoken audio, including audio, notes, transcribed text, and video and present them in a temporally synchronized fashion.

Presentations, in addition to including a verbal element, often include a document of some type to serve as a visual aid. This document is generally in electronic form and often made available to the attendees before the presentation. Attendees often take notes on the document in printed or electronic form. The notes generally represent highlights of the verbal content that is not in the document. While taking notes, the attendee may lose focus on the verbal content and miss parts of the conversation. Also, there may be important verbal aspects that an attendee fails to capture.

Accordingly, it would be an advance in the state of the art to provide a device, system, and method to enable an attendee to capture and temporally associate, in real time, the audio of a presentation, the presentation document, and the presentation notes and an interface to interactively present this content in a temporally synchronized fashion.

The approaches described in this background section are those that could, but have not yet necessarily, been conceived or pursued. Accordingly, inclusion in this section should not be viewed as an indication that the approach(es) described is prior art unless otherwise indicated.

### SUMMARY OF THE INVENTION

A method for capturing and temporally synchronizing different aspect of a conversation is presented. The method includes receiving an audible statement, receiving a note temporally corresponding to an utterance in the audible statement, creating a first temporal marker comprising temporal information related to the note, transcribing the utterance into a transcribed text, creating a second temporal marker comprising temporal information related to the transcribed text, temporally synchronizing the audible statement, the note, and the transcribed text. Temporally synchronizing comprises associating a time point in the audible statement with the note using the first temporal marker, associating the time point in the audible statement with the transcribed text using the second temporal marker, and associating the note with the transcribed text using the first temporal marker and second temporal marker.

An electronic device is also presented. The electronic device comprises a means to capture a recording from an audible statement, a user interface configured to accept a note temporally corresponding to an utterance in the recording, a speech-to-text module configured to convert the utterance to a transcribed text, an utterance maker associated with the utterance, wherein the utterance marker comprises temporal information related to the utterance, and a note marker associated with the note. The note marker comprises temporal information related to the note, and a computer accessible storage for storing the recording, the transcribed text, the utterance marker, the note, the note marker. The note is temporally synchronized with the recording using the note marker, the recording is temporally synchronized with the transcribed text using the utterance marker, and the transcribed text is temporally synchronized with the note using the utterance marker and the note marker.

A system to capture and synchronize aspects of a conversation is also presented. The system comprises a microphone configured to capture a first recording of an audible statement, an electronic device in communication with the microphone, wherein the electronic device comprises a user interface configured to accept a first note temporally corresponding to an utterance in the first recording, and a computer readable medium comprising computer readable program code disposed therein. The computer readable program code comprises a series of computer readable program steps to effect receiving the first recording, receiving a first note temporally corresponding to an utterance in the first recording, creating a first temporal marker comprising temporal information related to the first note, transcribing the utterance into a transcribed text, creating a second temporal marker comprising temporal information related to the transcribed text, and temporally synchronizing the first recording, the first note, and the transcribed text. The temporally synchronizing comprises associating a time point in the first recording with the first note using the first temporal marker, associating the time point in the first recording with the transcribed text using the second temporal marker, and associating the first note with the transcribed text using the first temporal marker and second temporal marker.

### BRIEF DESCRIPTION OF THE DRAWINGS

Implementations will become more apparent from the detailed description set forth below when taken in conjunction with the drawings, in which like elements bear like reference numerals.

FIG. 1 is a diagram depicting an exemplary system to capture and temporally associate various aspects of a spoken audio event;

FIG. 2 is a block diagram depicting an exemplary general purpose computing device capable of capturing various aspects of a spoken audio event;

FIG. 3 is a representation of a exemplary recording UI to access synced audio, notes, and transcription;

FIG. 4 is a flowchart depicting an exemplary method of capturing and temporally associating multiple aspects of a conversation using near real-time transcription;

FIG. 5 is a flowchart depicting another exemplary method of capturing and temporally associating multiple aspects of a conversation using batch transcription processing;

FIG. 6 is a flowchart depicting a method of playback of temporally synchronized content;

FIG. 7 is a schematic of multiple coordinated devices for capturing the same or different aspects of the same conversation;

FIG. 8 is a flowchart depicting an exemplary method of correcting a low quality transcript;

FIGS. 9(a)-9(c) is a representation of a exemplary UI to correct a low quality transcript;

FIG. 10 is a schematic of a exemplary system that enables consuming various aspects of a conversation on a different device than was used to capture the aspects of the conversation; and

FIG. 11 is another schematic of multiple coordinated devices for capturing the same or different aspects of the same conversation.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

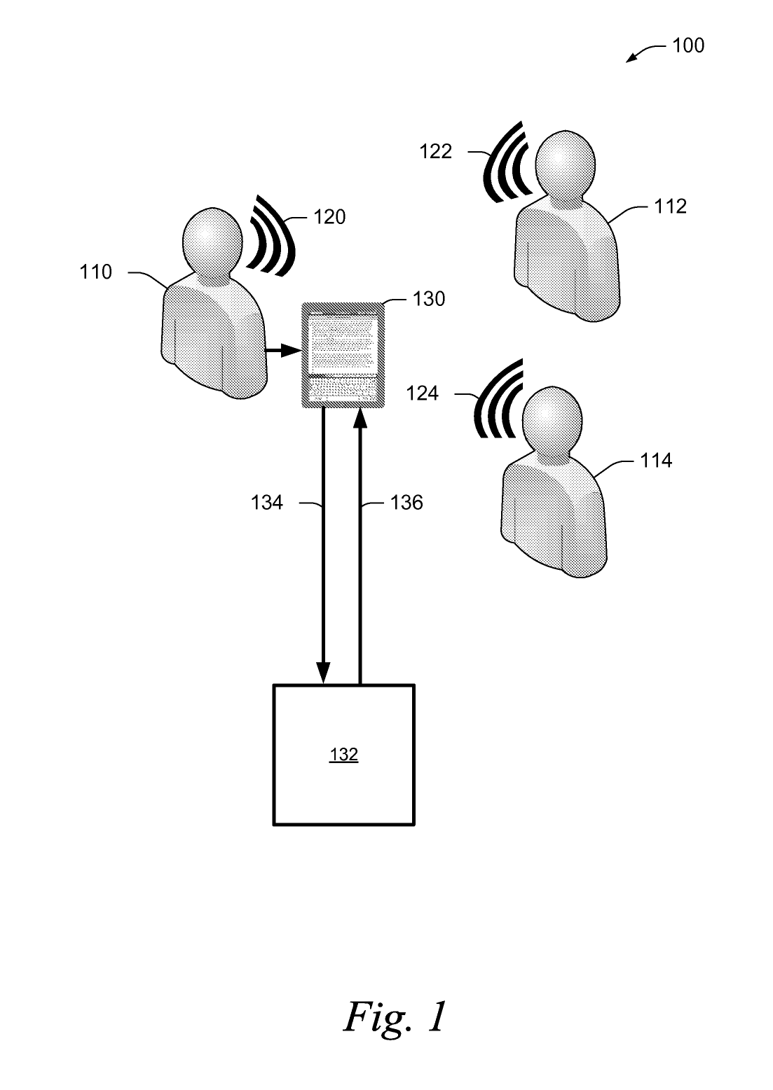

Referring to FIG. 1, a diagram depicts an exemplary system 100 to capture various aspects of a spoken audio event. Multiple individuals, 110, 112, 114, emit spoken audio content, 120, 122, 124, respectively while engaged in a conversation. During the conversation, individual 110 captures notes relating to, associated with, or otherwise triggered by the conversation, on a electronic device 130. The electronic device is capable of receiving text from the individual 110 and stores the text along with the specific time in which it was received. The electronic device is also capable of capturing the spoken audio content emitted from individuals 110, 112, and 114 and stores the audio with the specific time in which is was recorded. In one embodiment, the electronic device 130 temporally synchronizes the received text and the recorded audio.

For purposes of clarity, “temporally synchronized” as used herein, means using temporal information in temporal markers, such as a relative timestamp, an absolute timestamp, or other information that serves as an indication of when the text was entered or the audio received, to associate an element in the received text, such as a word, with a particular portion or point in the audio recording, and vise versa. The temporally synchronized audio and text can readily be display on a computing device. For purposed of clarity, a relative timestamp is a timestamp on a relative scale. For example, for a recording 10 minutes in duration, timestamps relative to the recording would have values from 0:00 to 10:00. In comparison, an actual timestamp would contain an actual time value (or data & time value), such as Jan. 28 08:38:57 2012 UTC, irrespective to the audio or video recording to which it is being temporally synchronized. Another example of an actual timestamp uses Unix time, or a similar scheme, which is a value representing the number of seconds from 00:00:00 UTC on Jan. 1, 1970 and is not a relative timestamp for purposes of this disclosure because it is not relative to the audio or video to which it is being temporally synchronized.

For purposes of clarity, an “utterance” as used herein, means a single sound that is the smallest unit of speech. A single utterance may be a full word (ex: “a”) or simply a portion of a word (the “rah” sound in red).

While the embodiment in FIG. 1 depicts three speakers (110, 112, 114) and one note-taker (110), any number of individuals may be speakers only, any number may be note-takers only, and any number may be both speakers and note-takers. For example, in a presentation setting, a single speaker emits audio content to any number of audience members who are capturing notes during the presentation. For another example, during an interview, there may be a single speaker and a single note taker. For yet another example, in a business meeting, there may be an equal number of speakers and note-takers.

The electronic device 130 is capable of receiving audio during the conversation. In one embodiment, the audio is captured by a microphone integrated or otherwise attached to the electronic device 130. In one embodiment, the audio is captured by a microphone on a separate device that is in data communication with the electronic device 130 using any wired or wireless data communication protocols, including without limitation Wi-Fi™, Bluetooth®, cellular technology, or technologies equivalent to those listed herein that allow multiple devices to communicate in a wired or wireless fashion.

The individual 110 enters notes on the electronic device 130. In one embodiment, the notes consist of textual information entered into the electronic device 130 during the conversation. In one embodiment, the notes consist of one or more bookmarks (i.e., a generic marker) entered into the electronic device 130 during the conversation. In one embodiment, the notes consist of one or more tags that stand for a particular meaning (i.e., a specific marker), such as “Important”, “To Do”, or “Follow up” entered into the electronic device 130 during the conversation. In one embodiment, the notes consists of drawing elements, such as lines, circles, and other shapes and figures, entered into the electronic device. In one embodiment, the notes consist of a combination of textual information, bookmarks, tags, and drawing elements entered into the electronic device 130 during the conversation.

The audio recording and associated temporal information is transmitted to an audio server 132 as indicated by arrow 134. In one embodiment, the transmission 134 is over a wired connection using any proprietary or open wired communication protocol, such as, without limitation, Ethernet. In one embodiment, the transmission 134 is over a wireless connection using any propriety or open wireless communication protocol, such as without limitation Wi-Fi™ or Bluetooth®.

In one embodiment, the audio server is a general purpose computing device running speech-to-text (“STT”) software and capable of two way communication. In one embodiment, the audio server 132 is part of the electronic device 130 and may be implemented as software running on generic hardware or implemented in specialty hardware, such as without limitation a micro device fabricated specifically, in part or in whole, for STT capability. In other embodiments, the audio server 132 is separate and distinct from the electronic device 130. For example, the audio server may be hosted on a server connected to the internet or may be hosted on a second electronic device.

After receiving the audio recording and associated temporal information, the audio server 132 converts the audio into text (“transcribed text”) and assigns temporal information to each “element” of the transcribed text using the received temporal information. In different embodiments, an “element” may be a paragraph, a sentence, a word, an utterance, or a combination thereof. For example, in one embodiment, each word of the transcribed text is assigned temporal information. In another embodiment, each letter of the transcribed text is assigned temporal information. In yet another embodiment, a larger group of words in the transcribed text, such as a sentence, paragraph, or page, is assigned temporal information.

The transcribed text and associated temporal information is transmitted back to the electronic device 130 as indicated by arrow 136. In one embodiment, the transmission 136 includes a network, such as a private network or the Internet. In one embodiment, the transmission 136 is over a wired connection using any proprietary or open wired communication protocol, such as Ethernet. In one embodiment, the transmission 134 is over a wireless connection using any propriety or open wireless communication protocol, such as, without limitation, Wi-Fi™, Bluetooth®, or IrDA.

The electronic device temporally synchronizes the audio recording, the notes, and the transcribed text using the temporal information associated with each. The electronic device presents a user interface (UI) to enable a user to interact with the various temporally synchronized aspects of the conversation.

In one embodiment, the electronic device 130 is capable of receiving a video during the conversation. In one embodiment, the video is captured by a camera integrated into the device. In one embodiment, the video is captured from a camera integrated into a second device that is in data communication with the electronic device 130 using any wired or wireless data communication protocols. As with the audio recording, temporal information, such as the specific time each portion of the video was recorded, is captured along with the video. The video recording is then temporally synchronized with the other aspects of the conversation (i.e., one or more of the audio recording, the notes, and the transcribed text). In one embodiment, the electronic device temporally synchronizes the audio recording, the notes, the transcribed text, and the video recording using the temporal information associated with each. The electronic device 130 presents a user interface (UI) to enable a user to interact with the various temporally synchronized aspects of the conversation.

In one embodiment, the electronic device 130 is capable of receiving a presentation or other document before the conversation. The audio recording is temporally synchronized with the presentation by, in one embodiment, noting the portion of the presentation viewed or interacted with on the electronic device 130 during the conversation.

For example, with regards to a presentation at a conference or meeting, the presentation may be received by the electronic device before, or at the start of, the presentation. As the electronic device records the audio portion of the presentation, temporal information is gathered as the attendee interacts with the presentation. For instance, as the attendee switches pages to following along with the speaker, a timestamp is associated with the page change.

In another instance, an attendee may indicated particular elements on a given page of the presentation that are relevant to the audio being captured. For example, as an image on page 4 of a given presentation is being discussed by the speaker, the attendee may select the image on the electronic device to create a timestamp. As another example, the attendee may select a particular bullet point, sentence, paragraph or word, that is being discussed by the speaker to create a timestamp.

Associating timestamps with individual elements in the presentation (or document) enables the audio portion of the presentation to be temporally synchronized with the presentation materials. In certain embodiments, in addition to temporally associating elements of the presentation with the presentation audio, the attendee can also add text that can be temporally synchronized with the audio. As such, the term “note” can be broadly defined as (i) any interaction by the user with the electronic device that is given a timestamp and (ii) any data received by the electronic device that is given a timestamp. As such, user notes includes without limitation, recording audio, entering a text note, entering a drawing, entering a tag, entering a bookmark, selecting an element of a presentation or document (for example, without limitation, a word, sentence, paragraph, bullet point, picture, or page), recording a video, or capturing a picture.

In other embodiment, the portion of the presentation being shown by the presenter is communicated to the electronic device 130 by the presentation device (not shown in FIG. 1). In such an embodiment, some temporal information (i.e., timestamps) relating to, for example, changing pages and advancing between presentation elements, are provided by the speaker and received by the attendee's electronic device from another device in communication with the attendee's electronic device.

The user notes are temporally synchronized with the presentation by, in one embodiment, matching the user note with the portion of the presentation viewed (or displayed by the presenter) at the time the note was taken. The transcribed text is temporally synchronized with the presentation by, in one embodiment, matching the temporal information on the audio recording associated with the transcribed text that matches the portion of the presentation viewed, interacted with, and/or displayed by the presenter while the audio recording was taken.

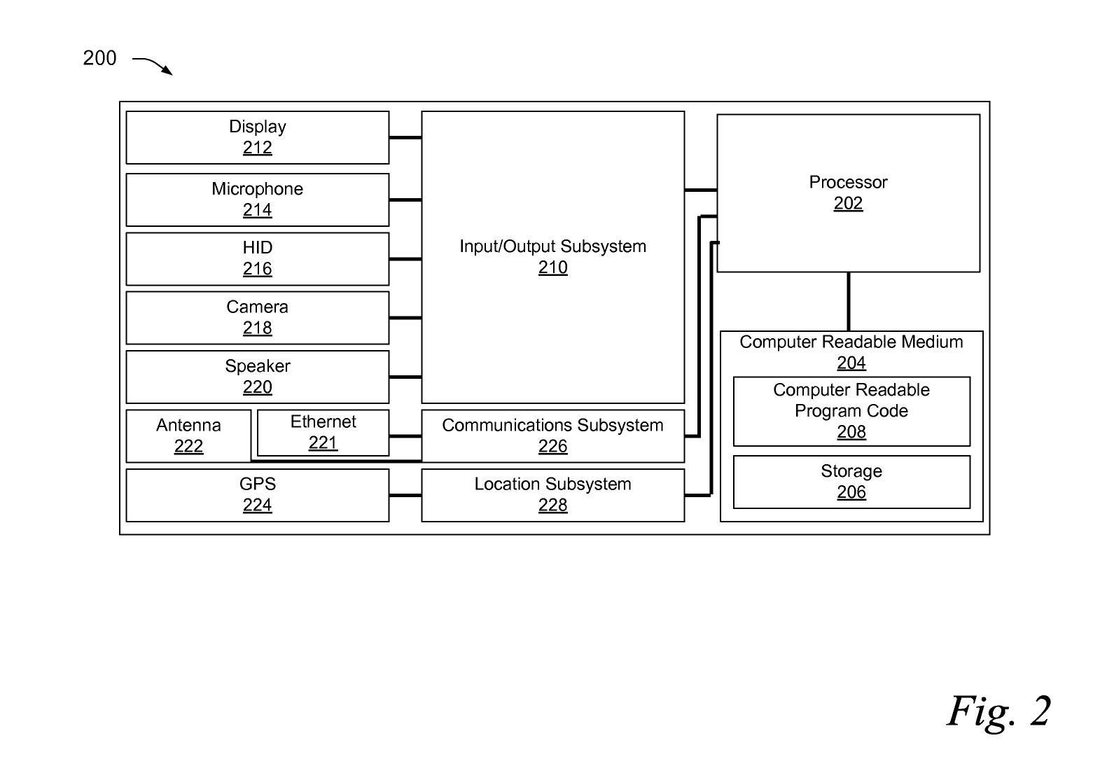

Referring to FIG. 2, a block diagram of a exemplary electronic device 200 is depicted. In one embodiment, the electronic device 200 is a mobile computing device, such as a smart phone (i.e., iPhone), a tablet computing device (i.e., an iPad), or a netbook. In one embodiment, the electronic device 200 is a general purpose computer, such as a desktop or laptop computer. A processor 202 is in communication with computer readable medium 204. The computer readable medium 204 contains computer readable/writable storage 206 (i.e., computer accessible storage). The storage 206 can be used to store digital representations of various aspects of a conversation, such as an audio recording, a video recording, notes, transcribed text, and translated text as well as associated metadata, such as without limitation, tag(s), or bookmark(s). The storage 206 can also be used to store temporal information associated with various aspects of the conversation, such as without limitation, timestamps.

The computer readable medium 204 also contains computer readable program code 208. The computer readable program code 208 includes instructions for the processor 202. The processor 202 reads the computer readable program code 208 and executes the instructions contained therein. In different embodiments, the program code 208 includes the instructions for performing the method steps described herein.

An input/output subsystem 210 is coupled to processor 202. The input/output subsystem 210 provides a two-way data communication link between the processor 202 and various devices. The display 212 is coupled to the input/output subsystem 210. The display is an output device that displays visual information.

The microphone 214 is coupled to the input/output subsystem 210. The microphone 214 is an input device that collects audio information from the environment. In one embodiment, microphone 214 is a unidirectional microphone. In one embodiment, microphone 214 is an omnidirectional microphone. In one embodiment, microphone 214 is integrated into the device 200. In one embodiment, microphone 214 is separate from the device 200, but in data communication with the device 200.

The human interface device (HID) 216 is coupled to the input/output subsystem 210. The HID 216 in an input device that allows an individual to enter data, such as text, bookmarks, notes, drawings and other non-audible information. In one embodiment, the HID 216 is a traditional keyboard or a mouse and keyboard combination. In one embodiment, the HID 216 is a touch sensor that is coupled to the display 212 to receive input from the user's finger(s). In one embodiment, the HID 216 is a surface capable of receiving input information from a stylus. In one embodiment, HID 216 is separate from the device 200, but in data communication with the device 200.

The camera 218 is coupled to the input/output subsystem 210. The camera 218 is an input device that collects visual information from the environment. In one embodiment, camera 218 is integrated into the device. In one embodiment, camera 218 is separate from the device 200, but in data communication with the device 200.

The speaker 220 is coupled to the input/output subsystem 210. The speaker 220 is an output device that broadcasts audio content. In one embodiment, the speaker 220 is monaural. In one embodiment, the speaker 220 is stereo. In one embodiment, the speaker 220 includes one speaker. In one embodiment, the speaker 220 includes multiple speakers.

A communications subsystem 226 is coupled to the processor 202. The communications subsystem 226 provides a two-way communication link between the processor and one or communication devices. In some embodiments, an Ethernet module 221 is coupled to communications subsystem 226. The Ethernet module 221 transfers data via a wire to a network, such as a private network or the Internet. In some embodiments, antenna 222 is coupled to communications subsystem 226. The antenna 222 enables the communications subsystem 226 to transfer data using a wireless data protocol.

A location subsystem 228 is coupled to the processor 202. The location system 228 transfers data based on the physical location of the electronic device 200. In one embodiment, the location subsystem can approximate the physical location of the device by using internet-based location services, which use IP address, router or access point identity, or other non-GPS technology to approximate the location of the device.

A GPS module 224 is coupled to the location subsystem 228. The GPS module 224 provides the location subsystem 228 with location information based off signals from an array of global positioning satellites.

Each block represents a function only and should not be interpreted to suggest a physical structure. Multiple blocks may be combined into one or more physical devices, or into the processor itself, or each block may be separated into multiple physical devices. Some block may be absent from some embodiments. Additionally, the recited modules are not intended to be limiting as additional modules may be included into the electronic device 200.

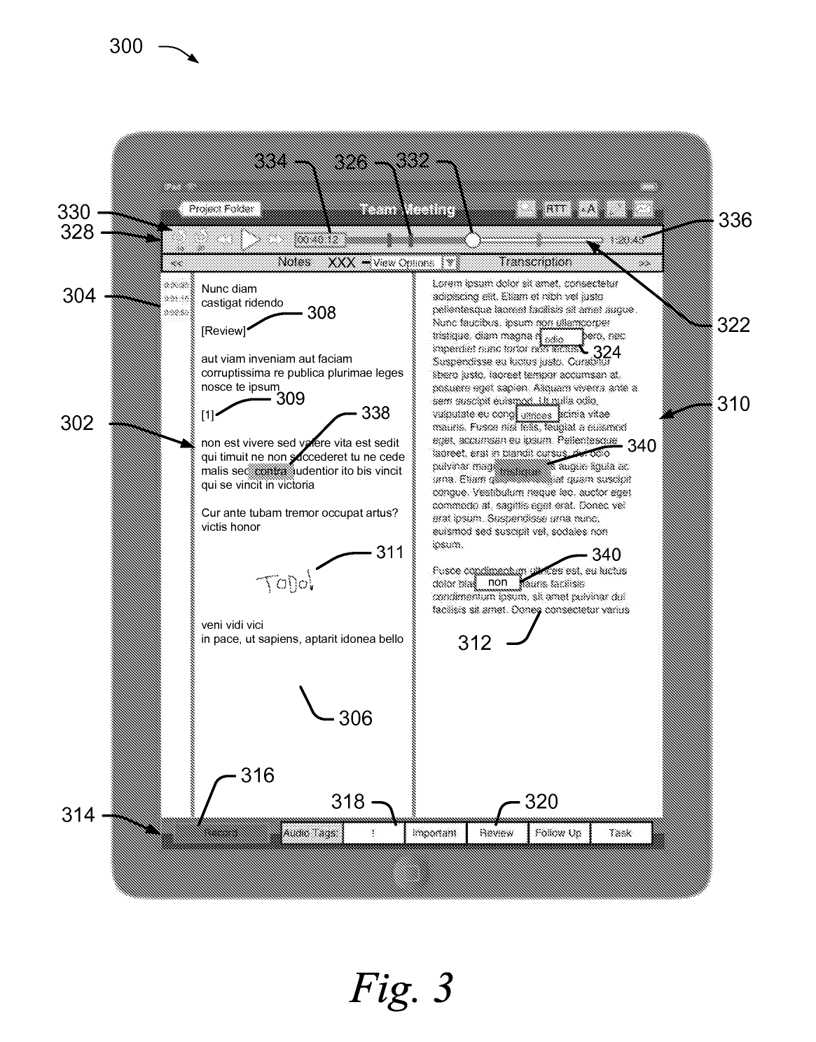

Referring to FIG. 3, a representation of an exemplary user interface (UI) 330 to access temporally synchronized audio, notes, and transcribed text is depicted. A note window 302 displays notes received during a conversation involving one or more speakers. For clarity, the “conversation” includes any spoken audio, including dictation audio, where a single person speaks and takes notes for later transcription. In one embodiment, the notes in note window 302 include textual information 306, tags 308, bookmarks 309 (i.e., generic tags), drawings 311, or a combination thereof.

In one embodiment, a margin 304 displays the timestamp (i.e., the time in hours:minutes:seconds from the start of the audio recording played at actual speed) for the first text element on the line. In different embodiments, the text element is a word, letter, sentence, or paragraph. The margin 304 provides, at a glance, temporal information relating to the textual information 306 in the note window 302.

A transcribed text window 310 displays the transcribed text 312 related to the conversation. In one embodiment, the first text element on each line of the transcribed text 312 corresponds to the timestamp in margin 304.

In one embodiment, a toolbar 314 contains recording controls 316. The recording controls 316 activate or deactivate the system to capture various aspects of the conversation. In one embodiment, when the system is inactive, the recording control 316 displays “Record” to active the system. In one embodiment, when the system is active, the recording control 316 displays “Stop” to deactivate the system.

Toolbar 314 contains audio tags (ex: 318 and 320). In one embodiment, the audio tags 318 and 320 are predetermined by the system. In one embodiment, the audio tags 318 and 320 are accepted by the user and displayed in toolbar 314. When an audio tag 318, 320 is selected, the text marked with the tag is highlighted in the note window 302 (ex: tag 308, corresponding to a selection of audio tag 320), and the transcribed text window 310, (ex: 324, indicating the word spoken when the audio tag 320 was selected to generate tag 308), and the time(s) corresponding to tag are highlighted in the audio progress bar 322 (ex: 326, indicating the point on the timeline of the conversation when the audio tag 320 was selected).

A playback control bar 328 includes information relating to the audio recording. Control buttons 330 enable playing, stopping, rewinding, and forwarding the audio recording. A current position indicator 332 indicates the current playback location of the audio. An indicator 334 displays the current playback location of the audio in hours:minutes:seconds. An indicator 336 displays the full length of the audio recording in hours:minutes:seconds. Tag/bookmark indicator 326 indicates the location in the audio recording of a tag or bookmark. A playback marker 338 indicates the location in the textual information 306 in the note window 302 for the current playback location in the audio recording. A playback marker 340 indicates the location in the transcribed text 312 in the transcribed text window 310 for the current playback location in the audio recording.

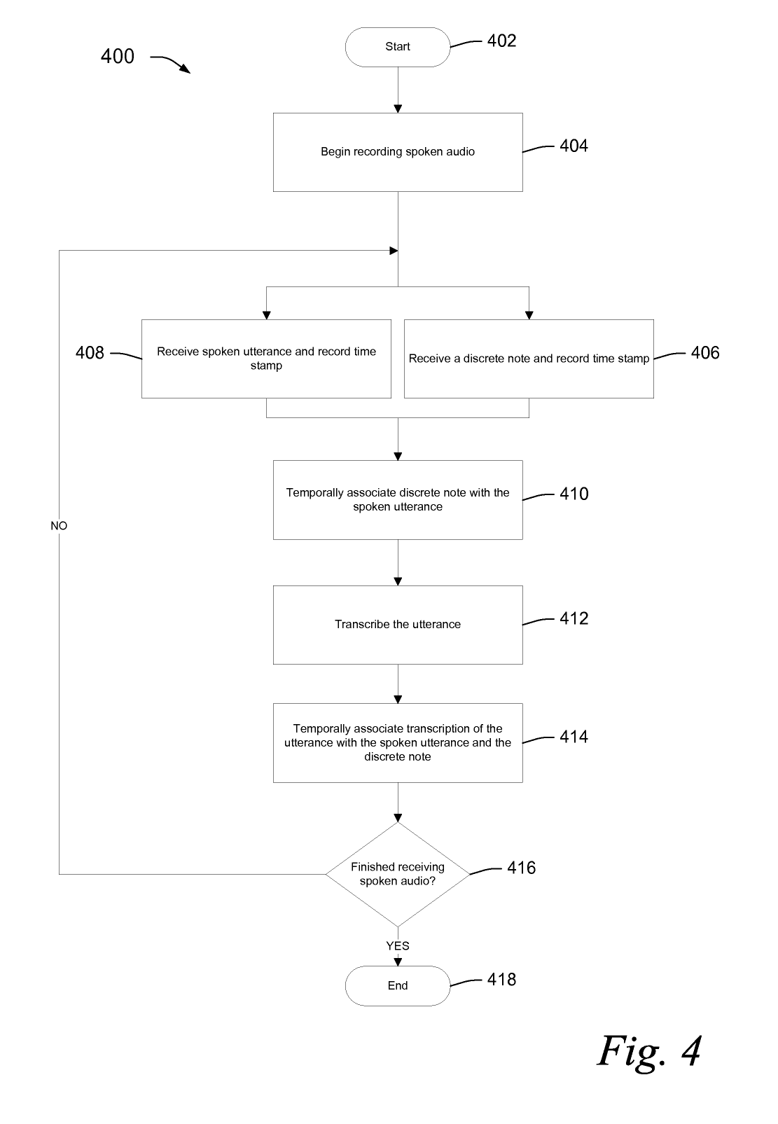

Referring to FIG. 4, a flowchart 400 of an exemplary method of capturing and temporally associating multiple aspects of a conversation using near real-time transcription is depicted. The method begins at 402. Audio is received and an audio recording begun at step 404.

A spoken utterance (i.e., a word or portion of a word) is received at step 408 and stored. A timestamp corresponding to the temporal position in the audio recording corresponding to when the utterance was received is stored.

A discrete note is received at step 406 and stored. In one embodiment, the discrete note is a single character. In one embodiment, the discrete note is a word. In one embodiment, the discrete note is a paragraph. In one embodiment, the discrete note is a bookmark. In one embodiment, the discrete note is a tag. A timestamp corresponding to the temporal position in the audio recording corresponding to when the note was received is stored. In one embodiment steps 408 and 406 occur simultaneously. For purposes of clarity, “simultaneously” means both the operation are performed by the method during an overlapping time period (i.e., at least one point between the time range spanning from the beginning and end of step 406 occurs within the time span ranging from the beginning and end of step 408).

In one embodiment, the timestamp is offset by a predetermined time period before or after the actual occurrence of the spoken utterance. In one embodiment, the offset is a time period before the actual occurrence of the spoken utterance to account for the delay of the user in inputting the note. In one embodiment, the offset is about 1 to 10 seconds before the actual occurrence of the spoken utterance. In one embodiment, the offset is 5 seconds before the actual occurrence of the utterance. In one embodiment, the offset is 8 seconds before the actual occurrence of the utterance.

The utterances and discrete notes are temporally associated using the respective stored timestamps at step 410. In one embodiment, the temporal association is accomplished by creating a separate file with indexes or links to specific locations in the recorded audio for each utterance and each discrete note.

The utterance is transcribed at step 412. In one embodiment, the transcription includes using STT technology to convert the utterance (in audio format) to text. In one embodiment, the transcription occurs on the same device that receives the audio and notes. In another embodiment, the transcription occurs on a device in data communications to the device that receives the audio and notes.

The transcribed text is temporally associated with the utterance and the discrete note at step 414. In one embodiment, the temporal association is accomplished by creating a separate file with indexes or links to specific locations in the recorded audio for each utterance and each discrete note.

The method determines if the audio recording has ceased at step 416. If the method determines that the audio recording has not ceased, the method transitions to step 408/406. If the method determines that the audio recording has ceased, the method transitions to step 418. The method ends at step 418.

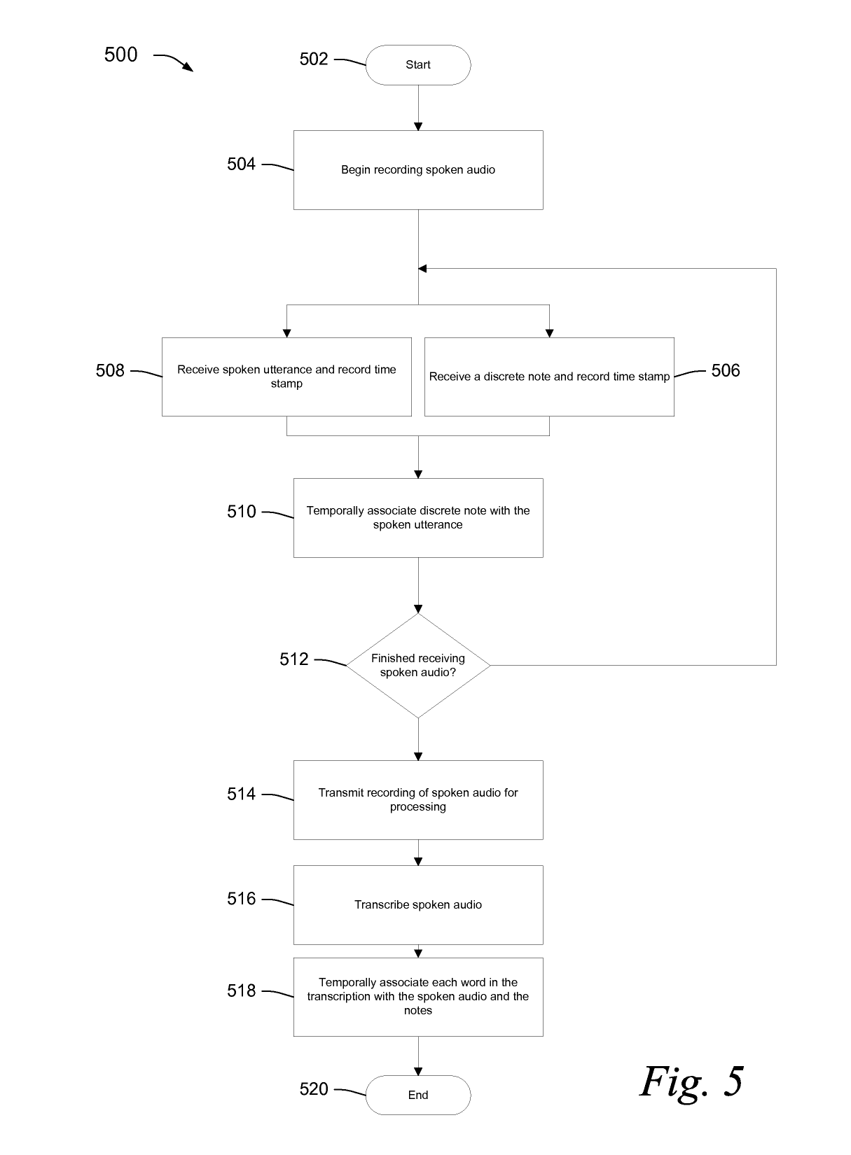

Referring to FIG. 5, a flowchart of another exemplary method of capturing and temporally associating multiple aspects of a conversation using batch transcription processing is depicted. The method begins at 502. Audio is received and an audio recording begun at step 504.

A spoken utterance (i.e., a word) is received at step 508. A timestamp corresponding to the temporal position in the audio recording corresponding to when the utterance was received is stored.

A discrete note is received at step 506. In one embodiment, the discrete note is a single character. In one embodiment, the discrete note is a word. In one embodiment, the discrete note is a paragraph. In one embodiment, the discrete note is a bookmark. In one embodiment, the discrete note is a tag. The discrete note and a timestamp corresponding to the position in the audio recording where the note was received is stored. In one embodiment, steps 508 and 506 occur simultaneously.

In one embodiment, steps 508 and 506 occur at different points in time (i.e., occur in non-overlapping time periods), when, for example, the notes are received during subsequent playback of the recording. In one embodiment, the timestamp associated with the note is a relative timestamp. In one embodiment, the timestamp associated with the note is an absolute timestamp.

In one embodiment, the timestamp associated with the note is given a value as if the note were captured during the recording. For example, if a text note (Text Note C) is added, after the recording is complete, between Text Note A with a timestamp of A and Text Note B with a timestamp of B, the timestamp of Text Note C will have a timestamp between that of A and B. This enables the user to organize notes added both during the recording and after the recording in a single timeline.

In one embodiment, the timeline associated with the note is given a value corresponding to a time after the recoding. For example, if a text note (Text Note C) is added, after the recording is complete, between Text Note A with a timestamp of A and Text Note B with a timestamp of B, the timestamp of Text Note C will have a timestamp after that of both A and B, and in fact after the latest timestamp associated with the recording. This enables the user to separately organize notes added during the recording with notes added after the conversation was complete.

In one embodiment, the timestamp associated with the note is given a relative timestamp (i.e., time only, with no date information) consistent with when the note was added relative to the other captured notes. For example, if a text note (Text Note C) is added, after the recording is complete, between Text Note A with a timestamp of A and Text Note B with a timestamp of B, the timestamp of Text Note C will have a timestamp (with time information only) between A and B.

In another embodiment, the timestamp associated with the note is given the actual timestamp in which the note was received (i.e., the actual date/time the note was added, which would be a time later than the latest point in the recording).

The utterances and discrete notes are temporally associated using the respective stored timestamps at step 510. In one embodiment, the temporal association is accomplished by creating a separate file with indexes or links to specific locations in the recorded audio for each utterance and each discrete note.

The method determines if the audio recording has ceased at step 512. If the method determines that the audio recording has not ceased, the method transitions to step 508/506.

If the method determines that the audio recording has ceased, the method transitions to step 514.

In one embodiment, the spoken audio is transmitted to a STT engine on another device for transcription by any wired or wireless data communication protocol at step 514. In one embodiment, the spoken audio is transcribed directly on the device by an STT engine.

The spoken audio is transcribed by the STT engine at step 516. In one embodiment, the STT engine is software running on a computing device. In one embodiment, the STT engine comprises one or more individuals manually transcribing the audio. In one embodiment, the STT engine is a combination of a software running on a computing device and one or more individuals manually transcribing the audio.

Each word in the transcribed text is temporally associated with the utterances and discrete notes at step 518. In one embodiment, the temporal association is accomplished by creating a separate file with indexes or links to specific locations in the recorded audio for each utterance and each discrete note.

In one embodiment, the software-transcribed text contains the temporal markers that link to the audio and the notes and the manually transcribed text does not. The software-transcribed text is aligned with the manually-transcribed text by identifying matching sections across each, thereby permitting the temporal markers in the software-transcribed text to be mapped to the manually transcribed text. In one embodiment, the mapping includes assigning identical temporal markers to matching text elements across both texts. In one embodiment, the mapping includes approximating the proper placement of temporal markers for non-matching text based on the closest matching text elements. This embodiment, thereby permits temporal markers to be added to highly accurate manual-transcribed text, thereby allowing the manually-transcribed text to be temporally synchronized with the notes and/or audio recording. The method ends at step 520.

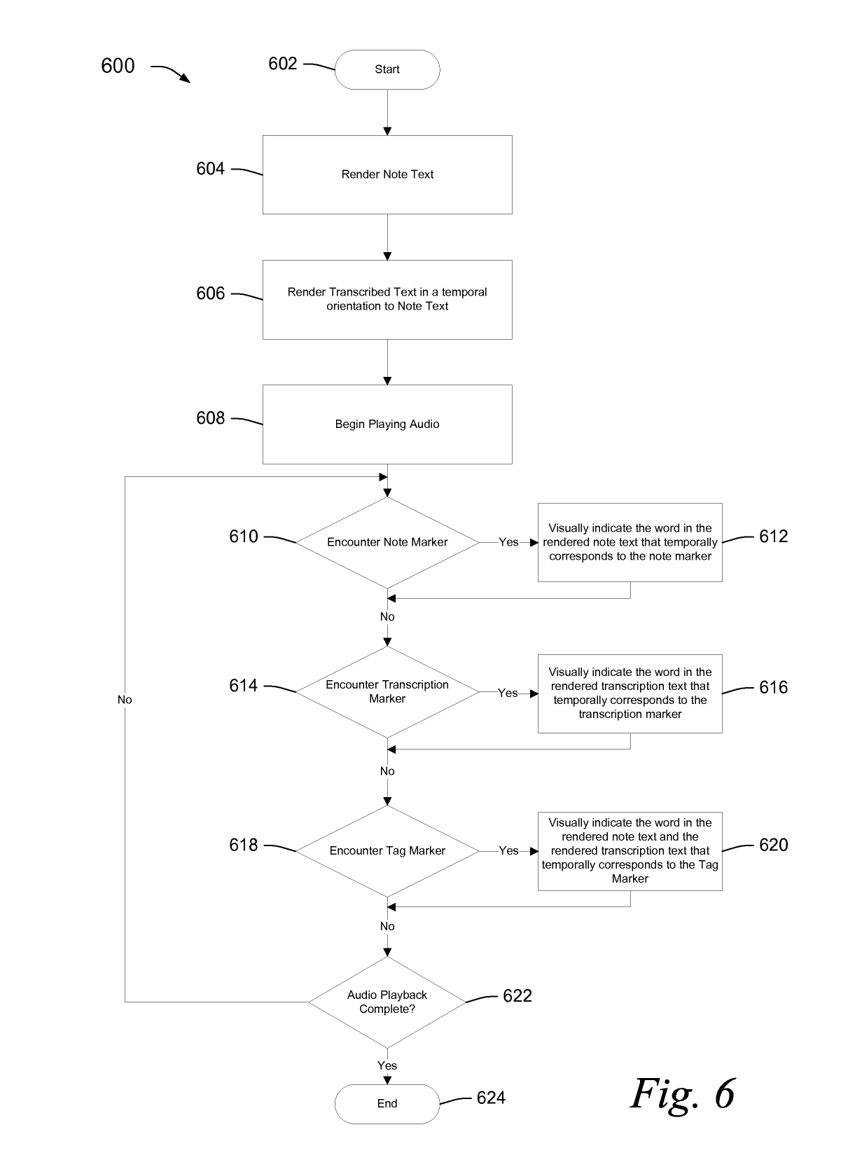

Referring to FIG. 6, a flowchart of a method of playback of temporally synchronized audio is depicted. The method begins at 602. The note text is rendered at step 604. In one embodiment, the rendering occurs on a digital display. The transcribed text is rendered at step 606. In one embodiment, the transcribed text is rendered in a temporal orientation to the note text. For example, the note text and the transcribed text are displayed side-by-side with the first word (or letter, sentence, or other element) of the note text having approximately the same timestamp as the first word (or letter, sentence, or other element) of the transcribed text.

A command to begin playback of the audio recording is received at step 608. During playback of the audio recording, the method determines if a note marker is encountered (i.e., a timestamp corresponding to a note element that matches the position in the playback of the recording) at step 610. If the method determines that a note marker is encountered, the method transitions to step 612.

A visual indication in the note text having approximately the same temporal value as the current position in the playback is presented at step 612. The granularity (i.e., letter, word, sentence, etc.) varies depending on the granularity of the note markers. In one embodiment, the relevant text is highlighted. In one embodiment, the relevant text is bolded. In one embodiment, the font of the relevant text is increased or otherwise changed. In one embodiment, the visual indication remains on the text until the next note marker is encountered, after which the visual indicator is removed and the text returned to the normal form. If the method determines that a note marker is not encountered, the method transitions to step 614.

During playback of the audio recording, the method determines if a transcription marker is encountered (i.e., a timestamp corresponding to a transcription element that matches the position in the playback of the recording) at step 614. If the method determines that a transcription marker is encountered, the method transitions to step 616. A visual indication in the transcription text having the same temporal value as the current position in the playback is presented at step 616. The granularity (i.e., letter, word, sentence, etc.) varies depending on the granularity of the transcription markers. In one embodiment, the relevant text is highlighted. In one embodiment, the relevant text is bolded. In one embodiment, the font of the relevant text is increased or otherwise changes. In one embodiment, the visual indication remains on the text until the next transcription marker is encountered, after which the visual indicator is removed and the text returned to the normal form. If the method determines that a transcription marker is not encountered, the method transitions to step 618.

During playback of the audio recording, the method determines if a tag/bookmark marker is encountered (i.e., a timestamp corresponding to a tag/bookmark element that matches the position in the playback of the recording) at step 618. If the method determines that a transcription marker is encountered, the method transitions to step 620. A visual indication in the note text and the transcription text having approximately the same temporal value as the current position in the playback is presented at step 616. In one embodiment, the relevant text is highlighted with the color corresponding to the assigned color of the tag/bookmark. In one embodiment, the relevant text is bolded. In one embodiment, the font of the relevant text is increased or otherwise changes. In one embodiment, the visual indication remains on the text until there is no longer a temporal overlap between the tag/bookmark marker and the text, after which the visual indicator is removed and the text returned to the normal form. If the method determines that a tag/bookmark marker is not encountered, the method transitions to step 622.

The method determines if the playback is complete at step 622. If the method determines that the playback is not complete, the method transitions to step 610. If the method determines that the playback is complete, the method transitions to step 624. The method ends at step 614.

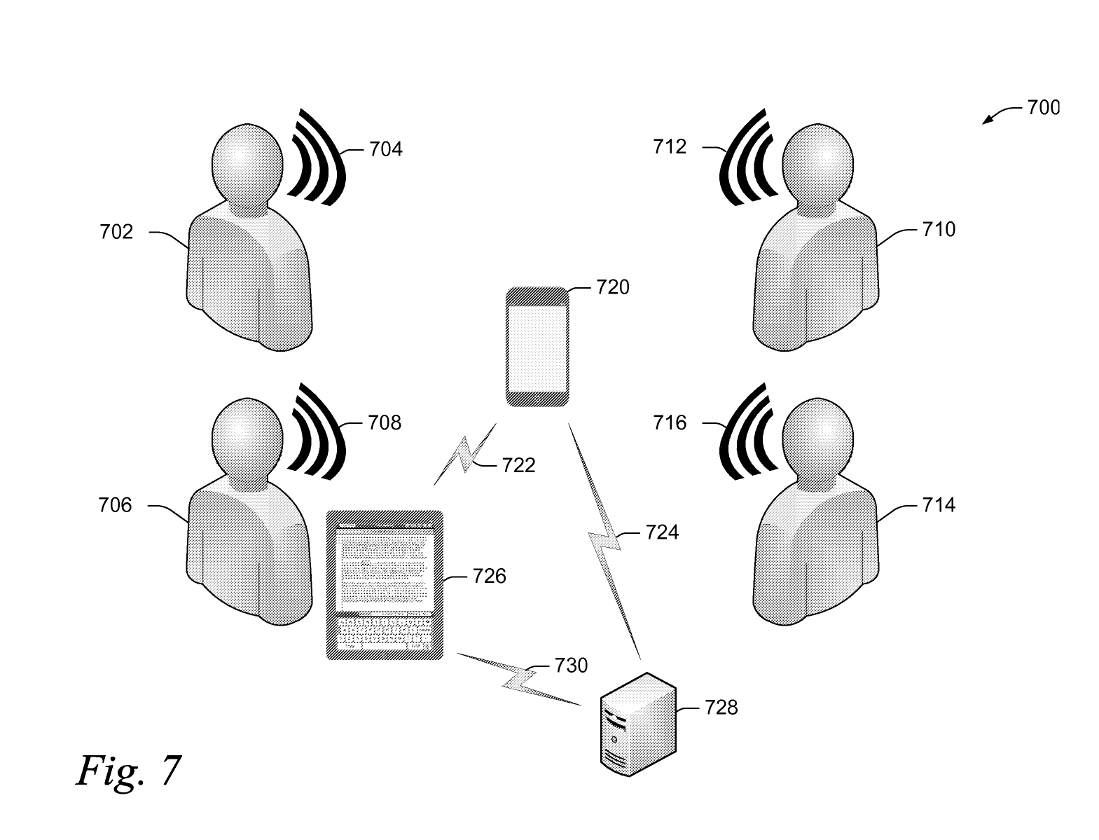

Referring to FIG. 7, a schematic 700 of multiple coordinated devices for capturing the same or different aspects of the same conversation is depicted. Multiple participants 702, 706, 710, and 714 engage in a conversation. In the depicted embodiment, there are 4 participants. In different embodiments, there is at least 1 participant. In other embodiments, there are more than 1 participant.

In one embodiment, every participant speaks at different points in the conversation, as indicated by symbols 704, 708, 712, and 716. In other embodiments, only a portion of the participants engaged in the conversation speak (i.e., some are listeners only).

Participant 706 uses an electronic note taking device 726, similar to that described in FIG. 2, to enter notes during the conversation. In different embodiments, the notes include text, tags, bookmarks, or a combination thereof. The electronic note taking device 726 is capable of capturing the audio (704, 708, 712, and 716) from the conversation. In one embodiment, the audio is captured directly by device 726. In one embodiment, the audio is captured by another device positioned near the conversation and capable of sending the captured audio to the device 726 by any wireless or wired means known in the art.

The electronic note taking device 726 is capable of sending the recorded audio to a server 728 by any wireless or wired means known in the art, represented by signal 730. The recording may be sent in real time or near real time (i.e., streamed) or sent in its entirety after the conversation has concluded or the recording stopped.

The electronic note taking device 726 is cable of transcribing the recorded audio. In different embodiments, the transcription may be performed on the device 726 or on a remote server, for example server 728.

The electronic note taking device 726 is capable of temporally associating the discrete notes, the recording, and the discrete elements in the transcription text.

A second recording device 720 is positioned to record the audio (704, 708, 712, and 716) from the conversation. In one embodiment, the recording device 720 may be a device similar to the electronic note taking device 726. In one embodiment, the recording device 720 is a mobile computing device, such as a smart phone, tablet PC, netbook, laptop, desktop computer, iPhone, iPad, or iPod Touch. In one embodiment, there are multiple recording devices 720 positioned at different locations during the conversation.

The recording device 720 is capable of sending the recorded audio to a server 728 by any wireless or wired means known in the art, represented by signal 724. The recording may be sent in real time or near real time (i.e., streamed) or sent in its entirety after the conversation has concluded or the recording stopped.

The electronic note taking device 726 is positioned away from the recording device 720. For example, if the participants are positioned around the conference table, the electronic note taking device 726 may be positioned in close proximity with individual 706, while the recording device 720 may be centrally positioned between the speakers near the center of the conference table.

As the conversation proceeds, the conversation is recorded on both devices 720 and 726 from different locations. In one embodiment, the devices 720 and 726 create an ad hoc microphone array. In one embodiment, the two recordings are sent to a server 728, as indicated by signals 724 and 730, and processed to differentiate the individual participants. In one embodiment, the two recordings are processed to determine the relative spatial location of each speaking participant. In one embodiment, the relative spatial location of each speaking participant is determined by techniques known in the art, including by comparing, for example, the relative volume and/or phase delay in the signals acquired by the two audio sources. In one embodiment, each speaking participant is differentiated by techniques known in the art, including by comparing, for example, the relative volume and/or phase delay in the signals acquired by the two audio sources.

While two recording locations, as depicted in FIG. 7, can fully differentiate multiple speakers in certain arrangements, additional recording devices at additional locations proximate to the speakers will increase the accuracy of the system to differentiate and/or locate each speaker.

In one embodiment, the devices 720 and 726 synchronize their internal clocks to enable a precise temporal comparison of the two recordings, thereby increasing the ability to differentiate and/or locate each speaker. In one embodiment, the synchronization may be accomplished by a wired or wireless communication between the devices as indicated by signal 722. In one embodiment, the synchronization may be accomplished by communication with server 728 as indicated by signals 724 and 730.

The information determined from processing the multiple audio recordings is incorporated with the temporally synchronized audio recording, notes, and transcribed text. For example, the text portions can be marked to indicate different speakers. In one embodiment, the multiple audio recordings can be utilized to increase the accuracy of the transcribed text. For example, one of the devices 720 or 726 may have a relativity superior microphone or be in a position to better pick up the speech from a particular participant. Combining the higher quality portions of recordings taken from different devices will thereby resulting in a higher accuracy transcription than with fewer recording devices. In one embodiment, the higher accuracy transcription (or portion of the transcription) is shared with each device 726 and 720.

In some embodiments, the separate recordings from different devices 720 and 726 (or additional devices) of the same conversation are combined to improve the quality of the audio used by the STT engine. In one embodiment, the recordings are divided into corresponding, temporally matching, segments. For each set of matching segments, particular recording portion having the highest quality audio is used to create a new composite recording that is, depending on the original recordings, of much higher quality than any individual original recording. The determination of “highest quality” will depend on the STT technology used and/or other factors, such as the volume level of the audio recording, acoustics, microphone quality, and amount of noise in the recording. In one embodiment, the composite recording is used to create the transcription.

In one embodiment, the separate recordings from different devices 720 and 726 (or additional devices) of the same conversation are each transcribed by an STT engine. A composite transcription text is derived from the individual results produced by the STT engine using a confidence level assigned to each text element by the STT enging. The composite text is produced by selecting the text element with the highest confidence level for each corresponding temporal segment across the individual transcriptions. For example, if in a first transcription, the text element at temporal location 1:42 is “come” with a confidence level of 50% and in a second transcription, the text element at temporal location 1:42 is “account” with a confidence level of 95%, then the text from the second transcription (i.e., “account”) is selected for the composite transcription. This embodiment is particularly useful in situations where, for example, each participant is phoning into the conversation via a conference speaker, but each is recording on their respective ends. In which case, the recorded audio spoken by a given participant that is captured on his own device is of higher quality than the same audio recorded by the other participant, on their device, over the conference speaker. The higher quality segments (i.e., each participant's own words recorded on his own device) are combined into a high quality composite recording. In one embodiment, the high quality composite recording is shared with each participant in the conversation and/or used to create a transcription of the conversation for each participant.

In one embodiment, the audio recordings of the same conversation from separate devices is matched by using location services (e.g., GPS) on the devices. Audio from multiple devices in both temporal and spatial proximity are thereby associated.

In one embodiment, the audio recordings of the same conversation from separate devices is matched by using acoustic fingerprinting technology, such as for example SoundPrint or similar technology. Acoustic fingerprinting technology is capable of quickly matching different recordings of the same conversation by using an algorithm.

In one embodiment, the identification of two or more devices recording the same conversation, using one of the techniques described above or other technology capable of making such an identification, is performed in real time or near real time (i.e., while the conversation is being recorded) by communication with a coordinating device, such as one of the devices or another device or server, using any wired or wireless technology known in the art. In another embodiment, the identification is performed at some time after the conversation has been recorded.

In one embodiment, each participant has a device identical or similar to electronic note taking device 726. The temporally synchronized notes (text, tags, and bookmarks) for each participant may be shared with the temporally synchronized notes (text, tags, and bookmarks) of the other participants for collaboration. In such an embodiment, the each set of temporally synchronized notes are temporally synchronized with each other set of temporally synchronized notes.

In one embodiment, the sharing is facilitated by server 728. In one embodiment, the devices (e.g. 726 and 720) directly communicate with each other to share this information. In one embodiment, a composite recording, derived from the best portions of the individual recordings from devices (e.g., 720 and 726) may be temporally synchronized and shared with the notes and transcribed text of at least one participant, thereby providing a superior audio recording for that participant (as compared to the audio recording captures on that participants device).

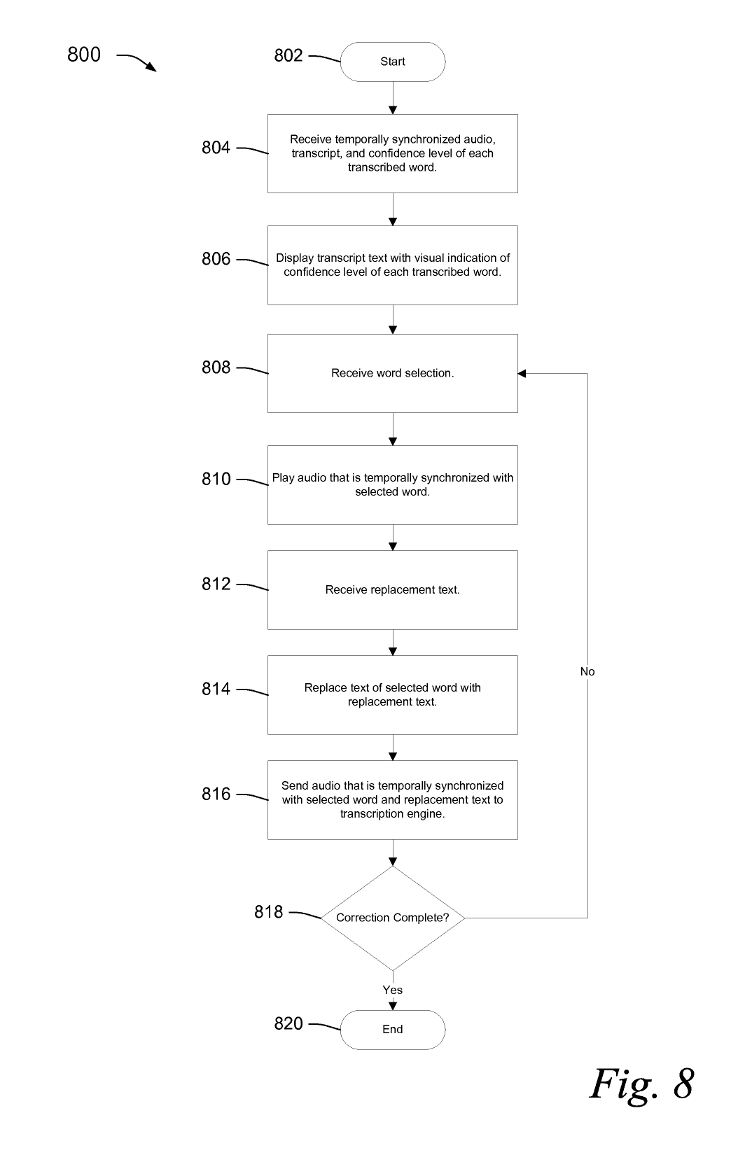

Referring to FIG. 8, a flowchart of an exemplary method of correcting a low quality transcript is depicted. The method begins at 802. Temporally synchronized audio, transcribed text, and the confidence level of each transcribed word are received at step 804. The confidence level of each transcribed word is determined by the STT engine using techniques known in the art. If the STT engine is able to transcribe a word with high accuracy, it is given a high confidence level. If, however, the STT is unable to transcribe the word with high accuracy, such as when the audio quality was low, there was interfering background noise, such as a rustling of paper or a cough, or multiple speakers were simultaneously talking, the word is marked with low confidence.

The transcribed text is displayed on an electronic display at step 806. Each word in the transcribed text is marked with a visual indication of the confidence level assigned to the word by the STT engine. In one embodiment, each word with a confidence level below a certain threshold is given a different font. In one embodiment, the threshold level is 80%.

A selection of a word (or phrase) with a low confidence level is received at step 808. The audio temporally synchronized with the word is played at step 810. Corrected text for the word (or phrase) is received at step 812. The low confidence word (or phrase) is replaced with the corrected text at step 814.

The audio temporally synchronized with the low confidence word (or phrase) along with the corrected text is sent to the STT engine at step 816. In one embodiment, the STT engine uses this information as a feedback mechanism to increase the accuracy of future transcriptions. In one embodiment, location information from the device (e.g., GPS) is used to identify the location of the recording. This location information is used to create location profiles for the STT engine. For example, the acoustics of an office location will likely be different from the acoustics of a home location or an outdoor location. By adding the location information to the STT engine has the potential to increase the performance of the STT engine.

The method determines whether the correction of the transcribed text is complete at step 818. If the correction is not complete, the method transitions back to step 808. If the correction is complete, the method transitions to 820. The method ends at 820.

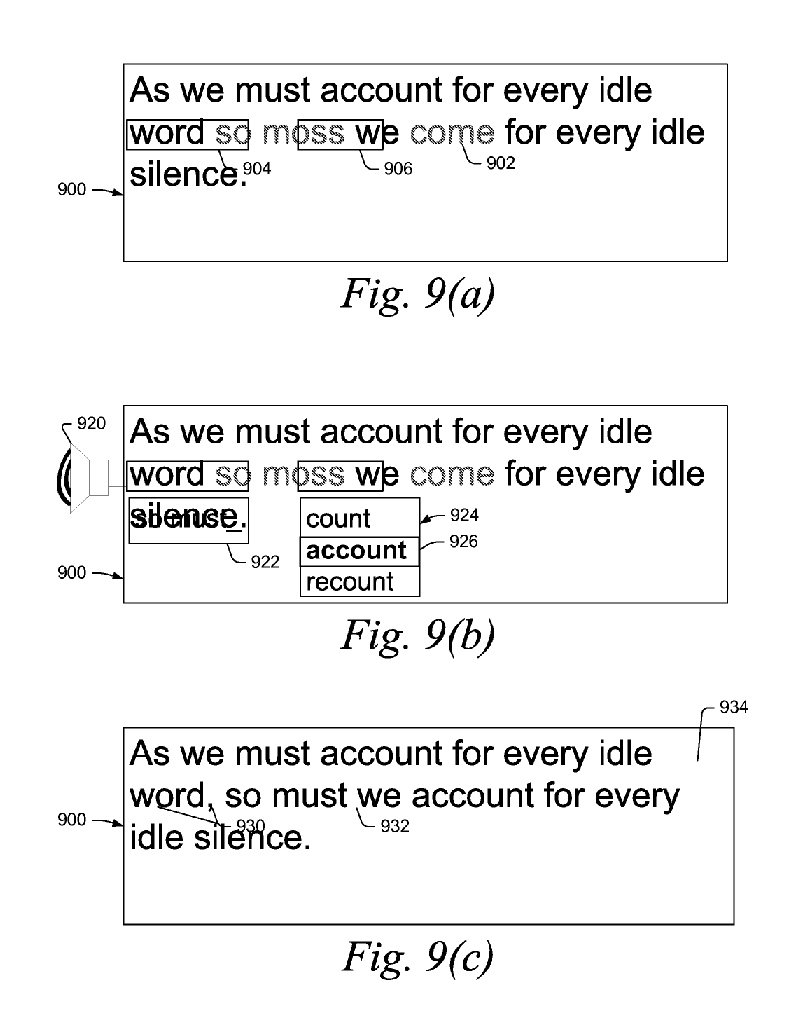

Referring to FIGS. 9(a)-9(c), a representation of an exemplary user interface (UI) to correct a low quality transcript is depicted. Turning to FIG. 9(a), a portion of text 900 transcribed with a STT engine is depicted. The words transcribed with high confidence (ex. 902) are displayed with normal font. The words transcribed with low confidence (ex. 904, 906) are displayed in red font.

Turning to FIG. 9(b), the phrase 904 is selected by a user. When selected, the audio temporally synchronized with the phrase 904 is played, as indicated by speaker 920. In another embodiment, the audio temporally synchronized with the phrase 904, as well as audio for a time period before and/or after the audio temporally synchronized with the phrase 904, is played. In different embodiments, the time period is about 0.5 second, about 1 second, about 3 seconds, or about 5 seconds. In different embodiments, the time period is between about 0.5 and about 10 seconds. In certain embodiments, the speed at which the phrase is played is variable.

In one embodiment, an edit box 922 is provided. The user interprets the audio and enters corrected text in the edit box 922.

The word 906 is selected by a user. When selected, the audio temporally synchronized with the word 906 is played. In one embodiment, a list 924 of potential corrections is provided. In various embodiments, the list is created by alternate results from the STT engine, by an algorithm that predicts the word (or phrase, as the case may be) based on a grammar or context analysis of the sentence, and/or by words (or phrases) similar to the word 906 (or phrase). The user selects the correct word 926 from the list 924.

Turning to FIG. 9(c), the corrected text is shown. The phrase 904 has been replaced by phrase 930. The word 906 has been replaced by word 932. The text 900 is also edited to add punctuation marks (ex. 934).

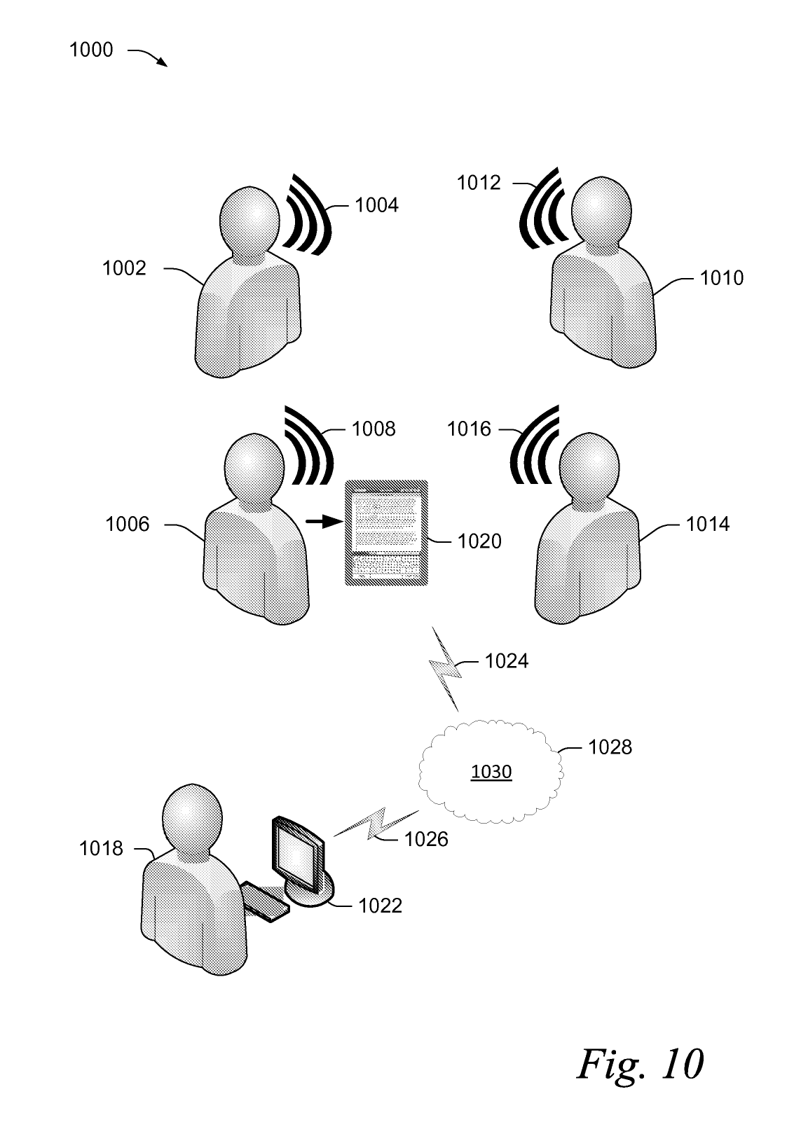

Referring to FIG. 10, a schematic of an exemplary system that enables consuming various aspects of a conversation on a different device than was used to capture the various aspects of the conversation is depicted. Participants 1002, 1006, 1010, and 1014 engage in a conversation. The audio 1004, 1008, 1012, and 1016 is recorded by an electronic note taking device 1020. In one embodiment, the device 1020 is the same as the device described in FIG. 1. The device 1020 simultaneously receives notes from the participant 1006 during the conversation. The recorded audio, the notes, and the transcribed text are temporally synchronized.

The temporally synchronized information is sent to a remote system 1030 as indicated by signal 1024. In one embodiment, the remote system 1030 is a cloud-based or managed service. In various embodiments, the remote system 1030 is a server or general purpose computer.

A user 1018 accesses the temporally synchronized information from a device 1022. The temporally synchronized information is accessed from the remote system 1030 as indicated by signal 1026. In one embodiment, the device 1022 is a personal computer or laptop. In one embodiment, the device 1022 is a mobile computing device, such as a smart phone, a tablet PC, or a netbook.

The user 1018 accesses the temporally synchronized information from device 1022. The user 1018 corrects the transcription (by using, for example, the method and UI shown in FIGS. 8 and 9), summarizes the notes, and/or consolidates the text/notes relating to the tags/bookmarks.

Changes to the temporally synchronized information by any person (ex. 1018 or 1006) are automatically synchronized to all other users (ex. 1018 or 1006) by the remote system 1030. For example, an assistant may correct the transcribed text (as shown in FIGS. 8 and 9), which corrected text is then automatically updated on device 1020 via remote system 1030 for participant 1006 to use. As another example, additional notes temporally corresponding to a particular point in the conversation may be edited, summarized, or added, and such changes or additions to the notes will be automatically updated on device 1020.

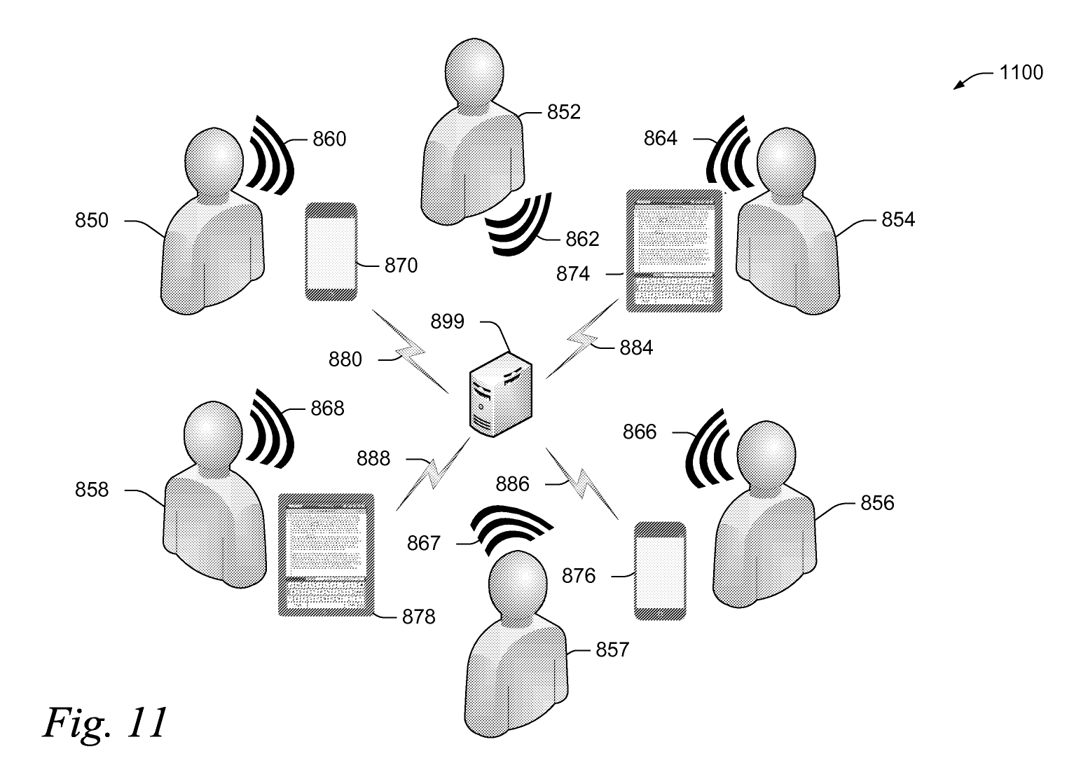

Referring to FIG. 11, a schematic of another embodiment of a system using multiple coordinated devices for capturing the same or different aspects of the same conversation is depicted. Participants 850, 852, 854, 856, 857, and 858 engage in a conversation. Audio is depicted by 860, 862, 864, 866, 867, and 868. Recording devices 870, 874, 876, and 878 are operated by 850, 854, 856, and 858, respectively. Each recording device 870, 874, 876, and 878 capture audio from a different spatial location. In one embodiment, the recording devices 870, 874, 876, and 878 are in data communication with a server 899 as indicated by signals 880, 884, 886, and 888. The data communication can be any wired or wireless data communication technology or protocol. In one embodiment, the recording devices 870, 874, 876, and 878 are in data communication with each other (signals not shown in FIG. 11). In one embodiment, the devices 870, 874, 876, and 878 communicate with each other to synchronize their internal clocks, thereby enabling the devices to 870, 874, 876, and 878 share temporally marked data (i.e., data, such as notes, text and audio with associated temporal markers) between devices. In one embodiment, the devices 870, 874, 876, and 878 send the recorded audio to server 899. In one embodiment, server 899 utilizes the multiple audio recordings of the same conversation, captured by devices 870, 874, 876, and 878 to identify individual speakers. In one embodiment, the identity of each speakers is determined by comparing the acoustic signature of each speaker to signatures of known individuals.

In one embodiment, server 899 utilizes the multiple audio recordings of the same conversation, captured by devices 870, 874, 876, and 878 to distinguish the different speakers participating in the conversation. While, in this embodiment, the actual identity of each speaker may not be determined, the portions of the recorded audio (and corresponding transcription) spoken by the six unique speakers (i.e., “speaker 1”, “speaker 2”, etc.) in FIG. 11 will be identified. The speakers are distinguished by the ad hoc microphone array created by devices 870, 874, 876, and 878. Utilizing relative differences in acoustic attributes, such as phase shifts, volume levels, as well as relative differences in non-acoustic aspects, such as GPS location, between the multiple recordings, each individual speaker is distinguished from the other speakers.

The device, system, and method described herein can be further enhanced with the addition of a translation engine.

Referring back to FIG. 3, in one embodiment, the textual information 306 and/or the transcribed text 312, each in a first language, are translated into the a second language using a text-based translation engine. The text-based translation engine accepts a first text in a first language and translates it to create a second text in a second language. Such engines are known in the art and are commercially available.

In one embodiment, the translation engine is on the same electronic device that accepts the textual information 306. In another embodiment, the translation engine is on another device in communication with the electronic device that accepts the textual information 306, such communication implemented by any wired or wireless technology known in the art.

In one embodiment, the UI 300 displays the textual information 306 in either the first or second language along with the transcribed text 312 in either the first or second language. The text in the second language (i.e., the translated text) is temporally synchronized in the same manner as the text in the first language (i.e., the timestamps for each word or phrase in the first language are applied to the translated word or phrase in the second language).

The translated text is an additional aspect of a conversation, along with the recorded audio, notes, and video, all of which may be temporally synchronized as described in this application. In one embodiment, the translated text, either notes, transcription, or both, is shared in real time or near real time with other participants in the conversation. As such, this provides a multi-language collaboration tool useful for international meetings or presentations. A first user of the electronic device represented in FIG. 3, who is listening to a speaker in a first language (ex: English) would be presented with a transcription of the speaker's speech, where the transcription is translated into a second language (ex: Mandarin). In addition, the notes taken in English by a second user would also be translated and presented to the first user in Mandarin. Additional notes taken in Mandarin by the first user would, in turn, be translated and presented to the second user. As such, the temporally synchronized information coupled with real time, near real time, or delayed transcription as described herein would be a very useful communication and collaboration tool for multi-lingual speeches, presentations, conferences, conversations, meetings, and the like.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Electronic devices, including computers, servers, cell phone, smart phone, and Internet-connected devices, have been described as including a processor controlled by instructions stored in a memory. The memory may be random access memory (RAM), read-only memory (ROM), flash memory or any other memory, or combination thereof, suitable for storing control software or other instructions and data. Some of the functions performed by these electronic devices have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of a method have been described with reference to flowcharts, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiment(s).

What is claimed is:

1. A method performed by a device, comprising:
receiving an audible statement;
receiving a note temporally corresponding to an utterance in said audible statement;
creating a first temporal marker comprising temporal information related to said note;
transcribing said utterance into a transcribed text;
creating a second temporal marker comprising temporal information related to said transcribed text;
temporally synchronizing said audible statement, said note, and said transcribed text, comprising:
associating a time point in said audible statement with said note using the first temporal marker;
associating said time point in said audible statement with said transcribed text using said second temporal marker; and
associating said note with said transcribed text using the first temporal marker and second temporal marker.

2. The method of claim 1, wherein said note is selected from the group consisting of text, a drawing, a tag, a bookmark, an element in a document, a picture, and a video.

3. The method of claim 1, wherein creating said first temporal marker comprises:
capturing a time in which the first note was received; and
subtracting an offset from said time to create the first temporal marker, wherein said offset is between 1 and 10 seconds.

4. The method of claim 1, further comprising:
receiving a second note temporally corresponding to said utterance;
creating a third temporal marker comprising temporal information related to said second note; and
wherein said temporally synchronizing further includes said second note and further comprises associating said time point in said audible statement with said second note using said third temporal marker.

5. The method of claim 1, further comprising:
translating said utterance into a translated text;
creating a third temporal marker comprising temporal information related to said translated text; and
wherein said temporally synchronizing further includes said translated text and further comprises associating said time point in said audible statement with said translated text using said third temporal marker.

6. The method of claim 1, further comprising:
displaying a representation of an audible statement with a temporal indicator, wherein the temporal indicator is a visual representation of a playback position;
displaying said transcribed text alongside said note;
receiving a play command;
playing the audible statement;
updating the temporal indicator;
visually indicating the note when said playback position matches said first temporal marker; and
visually indicating the transcribed text when said playback position matches said second temporal marker.

7. The method of claim 1, wherein said receiving an audible statement comprises receiving an audible statement along with video associated with said audible statement.

8. An electronic device comprising:
a means to capture a recording from an audible statement;
a user interface configured to accept a note temporally corresponding to an utterance in said recording;
a speech-to-text module configured to convert said utterance to a transcribed text;
an utterance maker associated with said utterance, wherein the utterance marker comprises temporal information related to said utterance;
a note marker associated with said note, wherein the note marker comprises temporal information related to said note; and
a computer accessible storage for storing the recording, the transcribed text, the utterance marker, the note, the note marker, wherein:
the note is temporally synchronized with the recording using the note marker;
the recording is temporally synchronized with the transcribed text using the utterance marker; and
the transcribed text is temporally synchronized with the note using the utterance marker and the note marker.

9. The electronic device of claim 8, wherein said means is a microphone on said electronic device or a microphone on a second device in data communication with said electronic device.

10. The electronic device of claim 8, wherein said speech-to-text module is configured to send said recording to a server and receive said transcribed text from said server.

11. The electronic device of claim 10, wherein said transcribed text was the result of a second recording captured by a second electronic device, wherein said recording and said second recording are of the same audible statement.

12. The electronic device of claim 8, further comprising a translation module configured to convert said utterance to a translated text.

13. The electronic device of claim 10, wherein the note is selected from the group consisting of text, a drawing, a tag, a bookmark, an element in a document, a picture, and a video.

14. A system to capture and synchronize aspects of a conversation, comprising
a microphone configured to capture a first recording of an audible statement;
an electronic device in communication with said microphone, wherein the electronic device comprises a user interface configured to accept a first note temporally corresponding to an utterance in said first recording; and
a computer readable medium comprising computer readable program code disposed therein, the computer readable program code comprising a series of computer readable program steps to effect:
receiving said first recording;
receiving a first note temporally corresponding to an utterance in said first recording;
creating a first temporal marker comprising temporal information related to said first note;
transcribing said utterance into a transcribed text;
creating a second temporal marker comprising temporal information related to said transcribed text; and
temporally synchronizing said first recording, said first note, and said transcribed text, comprising:
associating a time point in said first recording with said first note using the first temporal marker;
associating said time point in said first recording with said transcribed text using said second temporal marker; and
associating said first note with said transcribed text using the first temporal marker and second temporal marker.

15. The system of claim 14, further comprising:
a server in data communication with said electronic device; and
a second microphone in communication with a second electronic device configured to capture a second recording of said audible statement, wherein said transcribing said utterance comprises:
evaluating the audio quality of the first recording and the second recording;
selecting, from the first recording and the second recording, a best recording that will produce the most accurate transcribed text with respect to the audible statement; and
transcribing the best recording to create the transcribed text.

16. The system of claim 15, wherein said transcribing said utterance is performed on said server.

17. The system of claim 14, wherein:
said computer readable program steps further include translating said utterance into a transcribed text; and
said temporally synchronizing further includes said translated text and further comprises associating said time point in said first recording with said translated text using said third temporal marker.

18. The system of claim 14, further comprising a second electronic device comprising a user interface configured to accept a second note temporally corresponding to an utterance in said first recording, wherein:
said computer readable program steps further include:
receiving said second note; and
receiving a third temporal marker comprising temporal information related to said second note; and
said temporally synchronizing further includes said second note and further comprises associating said time point in said first recording with said second note using said third temporal marker.

19. The system of claim 14, wherein the first note is selected from the group consisting of text, a drawing, a tag, a bookmark, an element in a document, a picture, and a video.

20. The system of claim 14, wherein said receiving said first recording comprises receiving both audio and video of said audible statement.
